(19) United States
(12) Patent Application Publication
(10) Pub. No.: US 2026/0348500 A1
(43) Pub. Date: Nov. 5, 2026

(54) PIPE JOINT

(71) Applicant: NITTA CORPORATION, Osaka-shi, Osaka (JP)

(72) Inventors: Koichiro KIMOTO, Nabari-shi, Mie (JP); Mizuho HITOTSUBASHI, Osaka-shi, Osaka (JP); Yasunori KUSU, Nabari-shi, Mie (JP)

(21) Appl. No.: 19/486,902

(22) PCT Filed: Feb. 16, 2024
(86) PCT No.: PCT/JP2024/005433

§ 371 Date: Nov. 21, 2025

(30) Foreign Application Priority Data
May 23, 2023 (JP) 2023-084967

(51) Int. Cl. F16L 37/23; F16L 21/02; F16L 37/34

(52) U.S. Cl. CPC F16L 37/23; F16L 21/02; F16L 37/34

(57) ABSTRACT

A pipe joint includes a male member and a female member that are connected to each other, wherein the female member includes a coupler body that has a through hole and allows the male member to be inserted into the through hole; an outer sleeve provided on an outer periphery of the coupler body and movable along a center axis of the through hole; a lock sleeve that is screwed with a male thread portion formed on the outer periphery of the coupler body and that rotates around the center axis to move along the center axis and locks the outer sleeve; and an adapter that is fastened to the coupler body by being screwed with the male thread portion and prevents the lock sleeve from coming off.

### TECHNICAL FIELD

The present invention relates to a pipe joint.

### BACKGROUND ART

A pipe joint is known in which a male member is inserted into a coupler body of a female member to connect a pipe. Patent Literature 1 discloses a pipe joint including an outer sleeve movably provided on an outer periphery of a coupler body.

In the pipe joint disclosed in Patent Literature 1, a female member includes a lock sleeve that is screwed with a male thread portion formed on the outer periphery of the coupler body. The outer sleeve is locked as the lock sleeve rotates and moves. The coupler body is provided with a flange portion that protrudes radially outward, and the flange portion prevents the lock sleeve from coming off.

### CITATION LIST

### Patent Literature

Patent Literature 1: WO 2015/137027

### SUMMARY OF THE INVENTION

### Technical Problem

In the pipe joint disclosed in Patent Literature 1, a flange portion provided on the coupler body prevents the lock sleeve from coming off. The flange portion protrudes radially outward, and thus, an overall length and an outer diameter of the coupler body are increased by the amount of the flange portion.

An object of the present invention is to provide a pipe joint capable of preventing a lock sleeve from coming off while reducing an overall length and an outer diameter of a coupler body.

### Solution to Problem

A pipe joint according to the present invention includes a male member and a female member that are connected to each other, in which the female member includes: a coupler body that has a through hole and allows the male member to be inserted into the through hole; an outer sleeve provided on an outer periphery of the coupler body and movable along a center axis of the through hole; a lock sleeve that is screwed with a male thread portion formed on the outer periphery of the coupler body and that rotates around the center axis to move along the center axis and locks the outer sleeve; and an adapter that is fastened to the coupler body by being screwed with the male thread portion and prevents the lock sleeve from coming off.

### Advantageous Effects of Invention

According to the present invention, the adapter is fastened to the coupler body and prevents the lock sleeve from coming off. Therefore, it is unnecessary to provide a flange portion that protrudes radially outward on the coupler body. The coupler body does not have the flange portion, so that a length of the flange portion is unnecessary, and an overall length also becomes small. Therefore, it is possible to provide a pipe joint capable of preventing a lock sleeve from coming off while reducing an overall length and an outer diameter of a coupler body.

### BRIEF DESCRIPTION OF DRAWINGS

FIG. 1 is a half-cut sectional view of a pipe joint according to a first embodiment, and shows a state where a male member and a female member are separated.

FIG. 2 is a half-cut sectional view of the pipe joint according to the first embodiment, and shows a state where the male member is inserted into the female member.

FIG. 3 is a half-cut sectional view of the pipe joint according to the first embodiment, and shows a state where a lock sleeve is moved from the state shown in FIG. 2 to come into contact with an outer sleeve.

FIG. 4 is an enlarged view of a portion A in FIG. 3.

FIG. 5 is a half-cut sectional view of a pipe joint according to a second embodiment, and shows a state where a male member and a female member are separated.

FIG. 6 is a half-cut sectional view of a pipe joint according to a third embodiment, and shows a state where a male member and a female member are separated.

### DESCRIPTION OF EMBODIMENTS

Hereinafter, embodiments of the present invention will be described in detail with reference to the drawings. Each embodiment described below is an example of the present invention, and the present invention is not limited thereto. In the following description of the embodiments, the same components are denoted by the same reference numerals, and the description thereof will be appropriately omitted.

### First Embodiment

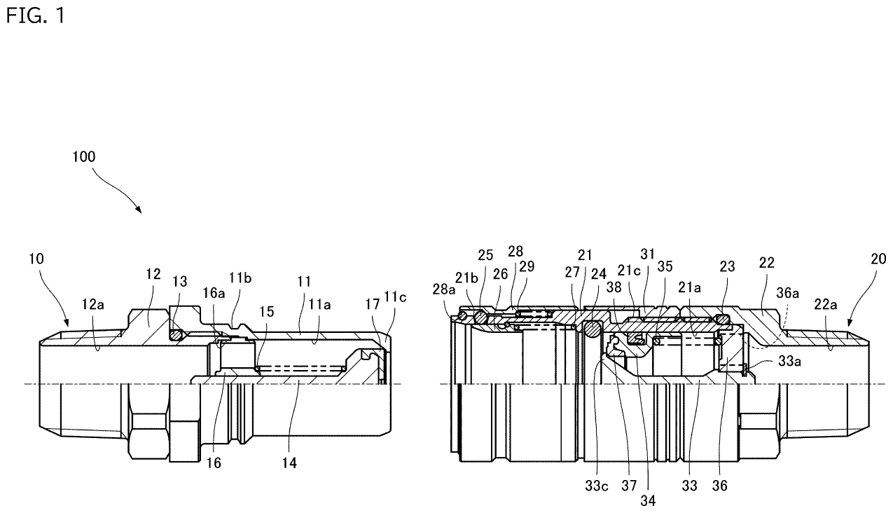

FIG. 1 is a half-cut sectional view of a pipe joint 100 according to a first embodiment. As shown in FIG. 1, the pipe joint 100 includes a male member 10 and a female member 20 that are connected to each other. FIG. 1 shows a state where the male member 10 and the female member 20 are separated.

The male member 10 includes a nipple 11 having a through hole 11a, and a male-side adapter 12 attached to the nipple 11. An annular groove 11b extending around a center axis of the through hole 11a is formed in an outer periphery of the nipple 11. An annular protrusion 11c that protrudes radially inward to the through hole 11a is formed on an inner periphery of the nipple 11. One opening of the through hole 11a is formed by the protrusion 11c.

A part of the male-side adapter 12 is inserted into the through hole 11a through the other opening of the through hole 11a and is screwed into a female thread portion formed on an inner periphery of the through hole 11a. A through hole 12a is formed in the male-side adapter 12, and a flow path that passes through the male member 10 is formed by the through hole 11a and the through hole 12a. A male thread portion for attachment to equipment or a pipe (not shown) is formed on the male-side adapter 12. In a state where the pipe is attached to the male-side adapter 12, the flow path of the male member 10 is continuous with an internal space of the pipe, and fluid flow between the flow path of the male member 10 and the internal space of the pipe.

A seal member 13 is provided between the nipple 11 and the male-side adapter 12. The seal member 13 performs sealing between the nipple 11 and the male-side adapter 12. The seal member 13 is, for example, an O-ring.

The male member 10 includes a male-side valve 14 that is housed in the through hole 11a, a male-side valve spring 15 that biases the male-side valve 14 toward the protrusion 11c of the nipple 11, and a male-side valve stop 16 that supports the male-side valve spring 15. The male-side valve stop 16 is held in the through hole 11a of the nipple 11 by the male-side adapter 12. A through hole 16a is formed in the male-side valve stop 16 so as not to block the flow path formed by the through hole 11a and the through hole 12a.

The male-side valve 14 is slidably supported by the male-side valve stop 16. The male-side valve 14 is provided with a male-side valve seat 17, and the male-side valve seat 17 abuts against the protrusion 11c due to a biasing force of the male-side valve spring 15. In a state where the male-side valve seat 17 abuts against the protrusion 11c, the flow path of the male member 10 is closed by the male-side valve seat 17. When the male-side valve 14 moves in a direction away from the protrusion 11c against the biasing force of the male-side valve spring 15, the male-side valve seat 17 moves away from the protrusion 11c, and the flow path of the male member 10 is opened.

The female member 20 includes a coupler body 21 having a through hole 21a, and a female-side adapter 22 attached to the coupler body 21. The nipple 11 of the male member 10 is inserted into the through hole 21a. A through hole 22a is formed in the female-side adapter 22. A part of the coupler body 21 is inserted into the through hole 22a, and a flow path that passes through the female member 20 is formed by the through hole 21a and the through hole 22a. A male thread portion for attaching a pipe (not shown) is formed on the female-side adapter 22. In a state where the pipe is attached to the female-side adapter 22, the flow path of the female member 20 is continuous with an internal space of the pipe, and fluid flow between the flow path of the female member 20 and the internal space of the pipe.

A seal member 23 is provided between the coupler body 21 and the female-side adapter 22. The seal member 23 performs sealing between the coupler body 21 and the female-side adapter 22. The seal member 23 is, for example, an O-ring.

A seal member 24 is provided at an inner periphery of the coupler body 21. In a state where the nipple 11 of the male member 10 is inserted into the through hole 21a of the coupler body 21, the seal member 24 is disposed between the coupler body 21 and the nipple 11, and performs blocking between the coupler body 21 and the nipple 11. The seal member 24 is, for example, an O-ring.

The female member 20 also includes a valve receiver 33 that is housed in the through hole 21a, a female-side valve 34 disposed between an inner periphery of the through hole 21a and an outer periphery of the valve receiver 33, a female-side valve spring 35 that biases the female-side valve 34, and a female-side valve stop 36 that supports the female-side valve spring 35. The female-side valve stop 36 is fixed to the coupler body 21 by the female-side adapter 22. A through hole 36a is formed in the female-side valve stop 36 so as not to block the flow path formed by the through hole 21a and the through hole 22a.

The valve receiver 33 is fixed to the female-side valve stop 36 using a snap ring 33a. An annular protrusion 33c that protrudes radially outward from the through hole 21a is formed on the outer periphery of the valve receiver 33. The female-side valve 34 is formed in an annular shape, and the valve receiver 33 is inserted through the female-side valve 34. The female-side valve 34 slides freely along the inner periphery of the through hole 21a. A seal member 38 is provided on the outer periphery of the female-side valve 34, and the seal member 38 performs blocking between the inner periphery of the through hole 21a and the outer periphery of the female-side valve 34. The seal member 38 is, for example, a V-seal.

The female-side valve spring 35 biases the female-side valve 34 toward the protrusion 33c of the valve receiver 33. The female-side valve 34 is provided with a female-side valve seat 37, and the female-side valve seat 37 abuts against the protrusion 33c due to a biasing force of the female-side valve spring 35. In a state where the female-side valve seat 37 abuts against the protrusion 33c, the flow path of the female member 20 is closed by the female-side valve seat 37. When the female-side valve 34 moves in a direction away from the protrusion 33c against the biasing force of the female-side valve spring 35, the female-side valve seat 37 moves away from the protrusion 33c, and the flow path of the female member 20 is opened.

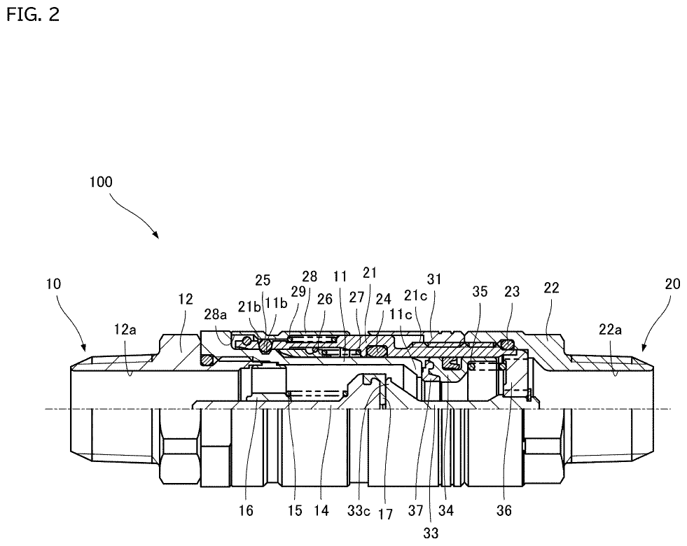

FIG. 2 is a half-cut sectional view of the pipe joint 100, and shows a state where the male member 10 is inserted into the female member 20. As shown in FIG. 2, when the nipple 11 is inserted into the through hole 21a, the valve receiver 33 of the female member 20 comes into contact with the male-side valve seat 17 and pushes the male-side valve 14 against the biasing force of the male-side valve spring 15. As a result, the male-side valve seat 17 moves away from the protrusion 11c of the nipple 11, and the flow path of the male member 10 is opened. The nipple 11 also comes into contact with the female-side valve seat 37 and pushes the female-side valve 34 against the biasing force of the female-side valve spring 35. As a result, the female-side valve seat 37 moves away from the protrusion 33c of the valve receiver 33, and the flow path of the female member 20 is opened.

When the nipple 11 is removed from the through hole 21a from the state shown in FIG. 2, the male-side valve 14 moves toward the protrusion 11c of the nipple 11 due to the biasing force of the male-side valve spring 15. As a result, the male-side valve seat 17 comes into contact with the protrusion 11c, and the flow path of the male member 10 is closed. The female-side valve 34 moves towards the protrusion 33c of the valve receiver 33 due to the biasing force of the female-side valve spring 35. As a result, the female-side valve seat 37 comes into contact with the protrusion 33c, and the flow path of the female member 20 is closed.

In this way, in the pipe joint 100, in a state where the male member 10 is not inserted into the female member 20, the flow paths in the male member 10 and the female member 20 are closed, and in the state where the male member 10 is inserted into the female member 20, the flow paths in the male member 10 and the female member 20 are opened. Therefore, the flow paths can be switched between open and closed simply by inserting and removing the male member 10 into and from the female member 20, and pipes (not shown) can be easily connected without leaking fluid.

As shown in FIG. 1, a ball hole 21b penetrating between the inner periphery and the outer periphery of the coupler body 21 is formed in the coupler body 21, and a ball 25 is disposed in the ball hole 21b. In the ball hole 21b, an opening in the outer periphery of the coupler body 21 is larger than a diameter of the ball 25, and an opening in the inner periphery of the coupler body 21 is smaller than the diameter of the ball 25. Therefore, only a part of the ball 25 can enter the through hole 21a of the coupler body 21 from the ball hole 21b. In a state where the ball 25 does not enter the through hole 21a of the coupler body 21 from the ball hole 21b, the ball 25 protrudes from the outer periphery of the coupler body 21.

An inner sleeve 26 and an inner spring 27 are provided in the inner periphery of the coupler body 21. The inner sleeve 26 is movable along a center axis of the through hole 21a. The inner spring 27 is supported by a step portion formed on the inner periphery of the coupler body 21, and biases the inner sleeve 26 toward a side opposite to a female-side adapter 22 side. In a state where the inner sleeve 26 is blocking the ball hole 21b, the inner sleeve 26 restricts the ball 25 from entering the through hole 21a of the coupler body 21 from the ball hole 21b. When the inner sleeve 26 moves against a biasing force of the inner spring 27, the inner sleeve 26 opens the ball hole 21b, and a part of the ball 25 can enter the through hole 21a of the coupler body 21 from the ball hole 21b.

An outer sleeve 28 and an outer spring 29 are provided on the outer periphery of the coupler body 21. The outer sleeve 28 is movable along the center axis of the through hole 21a. The outer spring 29 is supported by a step portion formed on the outer periphery of the coupler body 21, and biases the outer sleeve 28 toward the side opposite to the female-side adapter 22 side.

An annular concave portion 28a capable of receiving the ball 25 is formed on an inner periphery of the outer sleeve 28. The annular concave portion 28a has an inclined surface that converts a biasing force of the outer spring 29 to exert a force to push the ball 25 into the through hole 21a of the coupler body 21. In the state shown in FIG. 1, the ball 25 is in contact with the inclined surface. When the inner sleeve 26 moves against the biasing force of the inner spring 27 to open the ball hole 21b, the outer sleeve 28 moves due to the biasing force of the outer spring 29 and pushes the ball 25 into the through hole 21a of the coupler body 21. As a result, a part of the ball 25 enters the through hole 21a of the coupler body 21 from the ball hole 21b.

As shown in FIG. 2, when the nipple 11 is inserted into the through hole 21a until the annular groove 11b of the nipple 11 is continuous with the ball hole 21b, the inner sleeve 26 moves against the biasing force of the inner spring 27 to open the ball hole 21b, and the ball 25 can enter the annular groove 11b from the ball hole 21b. In this case, the outer sleeve 28 moves due to the biasing force of the outer spring 29 and pushes the ball 25 into the through hole 21a of the coupler body 21. As a result, a part of the ball 25 enters the annular groove 11b from the ball hole 21b, and the movement of the nipple 11 in a direction of being removed from the coupler body 21 is locked. Therefore, it is possible to prevent the male member 10 from coming off the female member 20.

In the state shown in FIG. 2, movement of the outer sleeve 28 in a direction toward the female-side adapter 22 is not locked. Therefore, if the male member 10 and the female member 20 rattle and elasticity of the seal member 24 decreases at low temperatures, fluid leakage may occur. In addition, the outer sleeve 28 may move minutely due to vibration of the male member 10 and the female member 20, and adhesion may occur at a contact location between an inner surface of the outer sleeve 28 and the ball 25.

Therefore, the pipe joint 100 is designed to be lockable the outer sleeve 28. Specifically, the female member 20 has a lock sleeve 31 that is screwed with a male thread portion 21c formed on the outer periphery of the coupler body 21. The lock sleeve 31 moves along the center axis of the through hole 21a by rotating around the center axis of the through hole 21a of the coupler body 21. When the lock sleeve 31 moves and comes into contact with the outer sleeve 28, the lock sleeve 31 locks the movement of the outer sleeve 28 in the direction toward the female-side adapter 22.

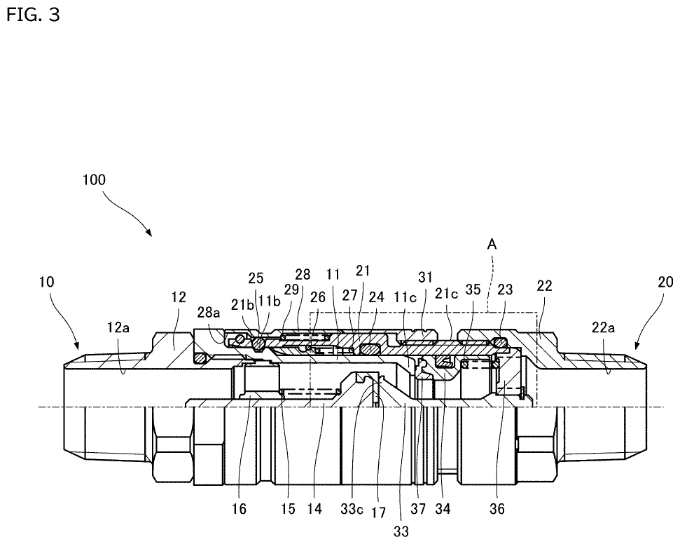

FIG. 3 is a half-cut sectional view of the pipe joint 100, and shows a state where the lock sleeve 31 is moved from the state shown in FIG. 2 to come into contact with the outer sleeve 28. In the state shown in FIG. 3, the lock sleeve 31 is in contact with the outer sleeve 28, and locks the movement of the outer sleeve 28 in the direction toward the female-side adapter 22. Therefore, rattling of the male member 10 and the female member 20 can be prevented, and the fluid leakage can be prevented even if the elasticity of the seal member 24 decreases at low temperatures. In addition, minute movement of the outer sleeve 28 can be prevented, and adhesion at a contact location between the inner surface of the outer sleeve 28 and the ball 25 can be prevented.

In order to release the lock on the nipple 11 by the ball 25, first, the lock sleeve 31 is rotated in a reverse direction to separate the lock sleeve 31 from the outer sleeve 28. Accordingly, the outer sleeve 28 becomes movable. Thereafter, the outer sleeve 28 moves toward the female-side adapter 22 against the biasing force of the outer spring 29, so that the annular concave portion 28a of the outer sleeve 28 can receive the ball 25. Accordingly, the ball 25 can move from the annular groove 11b of the nipple 11, and the lock on the nipple 11 by the ball 25 is released.

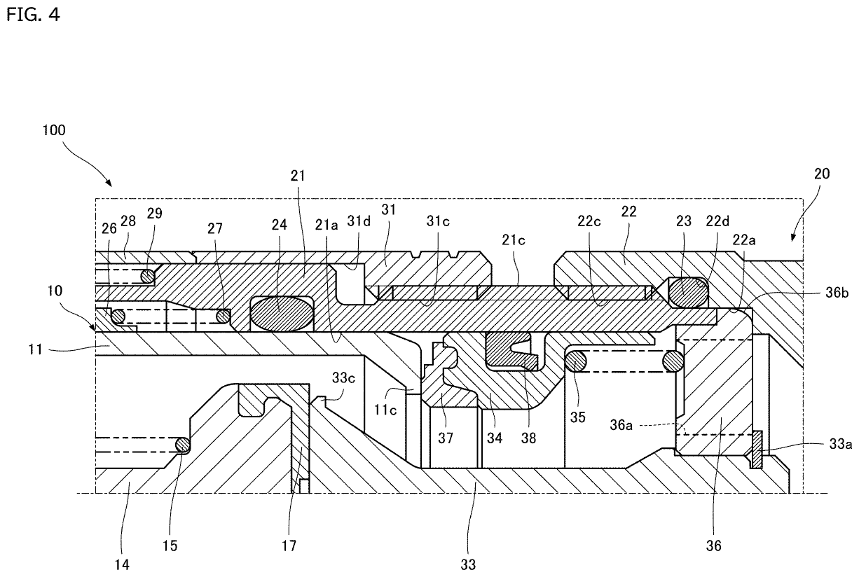

FIG. 4 is an enlarged view of a portion A in FIG. 3. As shown in FIG. 4, the female-side adapter 22 is screwed with the male thread portion 21c with which the lock sleeve 31 is screwed, and is tightened until the female-side adapter 22 comes into contact with the female-side valve stop 36, thereby being fastened to the coupler body 21. Therefore, when the lock of the nipple 11 by the ball 25 is released, the lock sleeve 31 moves only until the lock sleeve 31 comes into contact with the female-side adapter 22. Therefore, it is possible to prevent the lock sleeve 31 from coming off the coupler body 21.

In this way, the female-side adapter 22 is fastened to the coupler body 21 by being screwed with the male thread portion 21c, and prevents the lock sleeve 31 from coming off. Therefore, it is unnecessary to provide the coupler body 21 with a flange portion that protrudes radially outward to prevent the lock sleeve 31 from coming off. The coupler body 21 does not have the flange portion, so that a length of the flange portion is unnecessary, and an overall length also becomes small. Therefore, it is possible to prevent the lock sleeve 31 from coming off while reducing the overall length and an outer diameter of the coupler body 21.

The female-side adapter 22 has a female thread portion 22c that is screwed with the male thread portion 21c, and a seal housing portion 22d that houses the seal member 23. Specifically, the seal housing portion 22d is an annular concave portion formed on an inner periphery of the through hole 22a.

When the flange portion for preventing the lock sleeve 31 from coming off is not provided on the coupler body 21, if the seal housing portion 22d is provided on a front side of the female-side adapter 22 (left side in FIG. 4) with respect to the female thread portion 22c, there is a risk that the seal member 23 shifts to the front side of the female-side adapter 22. In this case, sealing performance of the seal member 23 decreases.

In the present embodiment, the seal housing portion 22d is provided on a rear side of the female-side adapter 22 (right side in FIG. 4) with respect to the female thread portion 22c. Therefore, in a state where the female thread portion 22c and the male thread portion 21c are screwed together, the seal member 23 is held on the rear side of the female-side adapter 22. Therefore, the seal member 23 can be prevented from decreasing in the sealing performance, and the fluid leakage between the coupler body 21 and the female-side adapter 22 can be prevented.

An outer periphery of the female-side valve stop 36 has an inclined surface 36b that slopes away from an inner periphery of the female-side adapter 22 in a direction toward the rear side of the female-side adapter 22. Therefore, when the female-side adapter 22 is tightened to the coupler body 21, the seal member 23 does not come into contact with a corner of the female-side valve stop 36. Therefore, damage to the seal member 23 can be prevented, and the fluid leakage between the coupler body 21 and the female-side adapter 22 can be more reliably prevented. The inclined surface 36b may be inclined linearly (in a tapered shape) or curvedly (in a rounded shape).

An inner periphery of the lock sleeve 31 has a female thread portion 31c that is screwed with the male thread portion 21c, and a non-threaded portion 31d that cannot be screwed with the male thread portion 21c. The non-threaded portion 31d extends toward the outer sleeve 28. Therefore, even if the male thread portion 21c and the outer sleeve 28 are separated and the female thread portion 31c cannot be brought close to the outer sleeve 28, the lock sleeve 31 can be brought into contact with the outer sleeve 28. Therefore, the movement of the outer sleeve 28 can be locked by the lock sleeve 31.

### Second Embodiment

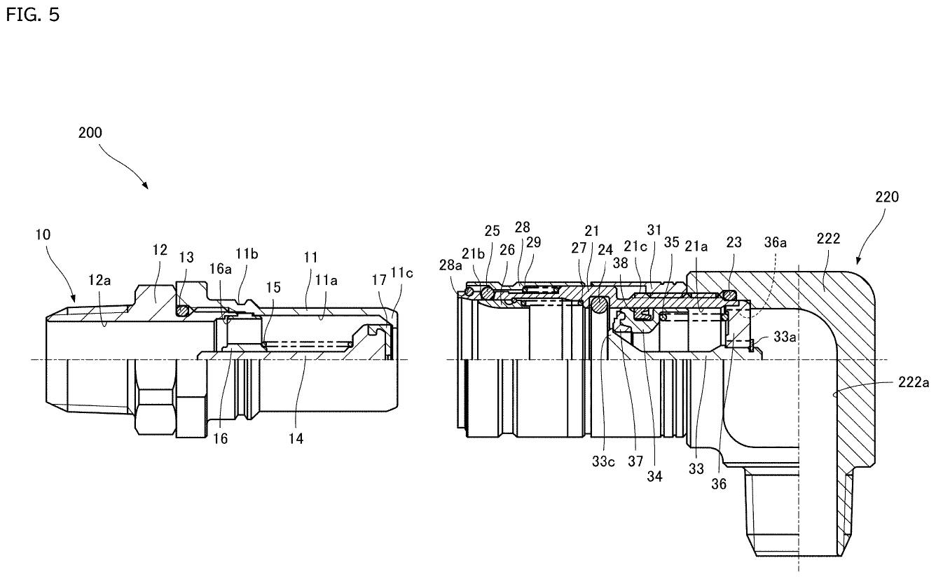

FIG. 5 is a half-cut sectional view of a pipe joint 200 according to a second embodiment, and shows a state where the male member 10 and a female member 220 are separated. Hereinafter, differences from the first embodiment will be mainly described, and the same reference numerals as those in the first embodiment are given to the same or corresponding configurations as those in the first embodiment in the drawings, and description thereof will be omitted.

In the pipe joint 100 according to the first embodiment (see FIGS. 1 to 4), the flow path of the female member 20 is linear, but in the pipe joint 200 according to the second embodiment (see FIG. 5), a flow path of the female member 220 is inclined. A through hole 222a of a female-side adapter 222 is bent at about 90 degrees, but the through hole 222 a may be bent at about 45 degrees or another angle.

In such a pipe joint 200, similar to the first embodiment, the female-side adapter 222 is also fastened to the coupler body 21 by being screwed with the male thread portion 21c, and prevents the lock sleeve 31 from coming off. Therefore, it is unnecessary to provide the coupler body 21 with the flange portion that protrudes radially outward to prevent the lock sleeve 31 from coming off. The coupler body 21 does not have the flange portion, so that a length of the flange portion is unnecessary and an overall length also becomes small. Therefore, it is possible to prevent the lock sleeve 31 from coming off while reducing the overall length and the outer diameter of the coupler body 21.

A position of the seal member 23 in the female member 220, a shape of the female-side valve stop 36, and a shape of the lock sleeve 31 are the same as those of the female member 20 in the first embodiment, and thus, operations and effects thereof will be omitted.

### Third Embodiment

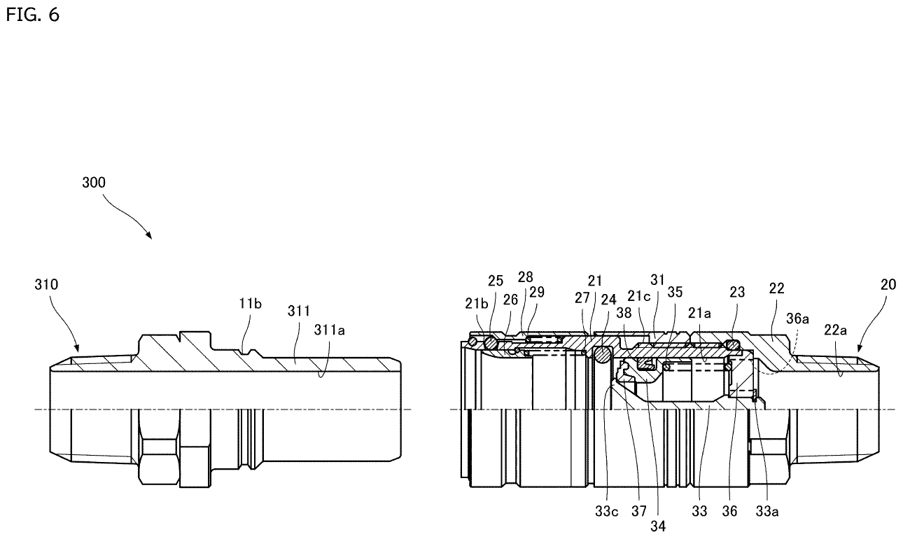

FIG. 6 is a half-cut sectional view of a pipe joint 300 according to a third embodiment, and shows a state where a male member 310 and the female member 20 are separated. Hereinafter, differences from the first embodiment will be mainly described, and the same reference numerals as those in the first embodiment are given to the Same or corresponding configurations as those in the first embodiment in the drawings, and description thereof will be omitted.

In the pipe joint 300 according to the third embodiment, the male member 310 does not include the male-side valve 14, the male-side valve spring 15, the male-side valve stop 16, and the male-side valve seat 17 of the first embodiment, and a male thread portion for attaching a pipe (not shown) is formed on a nipple 311. That is, the male member 310 only includes the nipple 311 having a through hole 311a.

In such a pipe joint 300, the same operations and effects as those of the first embodiment are also obtained.

Although not shown, in a configuration in which the male member 310 of the third embodiment is connected to the female member 220 of the second embodiment, the same operations and effects as those of the first embodiment are also exerted.

Although not shown, the female member 20 and the female member 220 may not include the valve receiver 33, the female-side valve 34, the female-side valve spring 35, the female-side valve stop 36, and the female-side valve seat 37. In such a configuration, if the female-side adapter 22 and a female-side adapter 222 are fastened to the coupler body 21 by being screwed with the male thread portion 21c and the lock sleeve 31 is prevented from coming off, similar to the first embodiment to the third embodiment, it is also possible to prevent the lock sleeve 31 from coming off while reducing the overall length and outer diameter of the coupler body 21.

Although the embodiments and modifications of the present invention have been described above, the present invention is not limited to the above-described embodiments and modifications, and can be appropriately modified within the scope of the gist of the present invention.

### REFERENCE SIGN LIST

100, 200, 300 pipe joint
10, 310 male member
20, 220 female member
21 coupler body
21c male thread portion
21a through hole
22, 222 female-side adapter (adapter)
28 outer sleeve
31 lock sleeve

1. A pipe joint comprising:
a male member and a female member that are connected to each other, wherein
the female member includes:
a coupler body that has a through hole and allows the male member to be inserted into the through hole;
an outer sleeve provided on an outer periphery of the coupler body and movable along a center axis of the through hole;
a lock sleeve that is screwed with a male thread portion formed on the outer periphery of the coupler body and that rotates around the center axis to move along the center axis and locks the outer sleeve; and
an adapter that is fastened to the coupler body by being screwed with the male thread portion and prevents the lock sleeve from coming off.

2. The pipe joint according to claim 1, further comprising:
a seal member that performs sealing between the coupler body and the adapter, wherein
the adapter has a female thread portion screwed with the male thread portion and a seal housing portion housing the seal member, and
the seal housing portion is provided on a rear side of the adapter with respect to the female thread portion.

3. The pipe joint according to claim 2, wherein
the female member further includes:
a valve that opens and closes a flow path formed by the through hole;
a valve spring that biases the valve; and
a valve stop that is fixed to the coupler body by fastening the adapter and supports the valve spring, wherein
an outer periphery of the valve stop has an inclined surface that slopes away from an inner periphery of the adapter in a direction toward the rear side of the adapter.

4. The pipe joint according to claim 1, wherein
an inner periphery of the lock sleeve has a female thread portion screwed with the male thread portion and a non-threaded portion unable to be screwed with the male thread portion, wherein
the non-threaded portion extends toward the outer sleeve.
